(19) United States
(12) Patent Application Publication
(10) Pub. No.: US 2003/0057605 A1
(43) Pub. Date: Mar. 27, 2003

(54) Method for producing components in the engine compartment of motor vehicles by means of thermoplastic materials

(76) Inventors: Matthias Schumann, Eppstein-Brcathel (DE); Ulrich Haack, Alsbach (DE); Holger Klink, Muhltal (DE); Olaf Herd, Munster (DE)

Correspondence Address: CONNOLLY BOVE LODGE & HUTZ, LLP, 1220 N MARKET STREET, P O BOX 2207, WILMINGTON, DE, 19899

(21) Appl. No.: 10/181,574

(22) PCT Filed: Jan. 18, 2001
(86) PCT No.: PCT/EP01/00524

(30) Foreign Application Priority Data
Jan. 21, 2000 (DE) 100 02 631.1
Jan. 21, 2000 (DE) 100 02 633.8

(51) Int. Cl. B29C 43/02

(52) U.S. Cl. 264/320

(57) ABSTRACT

The present invention relates to a process for producing components for the engine compartment with a relatively high degree of integration, where at least one thermoplastic polymer is preplastified and the plastified material in the plastic state is laid down in a defined manner in a compression mold and is molded in a subsequent compression procedure. The present invention further relates to the components produced by the present process, in particular labyrinth plates for automatic gearboxes.

The present invention relates to a process for producing components for the engine compartment of motor vehicles with thermoplastic materials, and to moldings produced by this process, in particular labyrinth plates for automatic gearboxes, comprising at least one thermoplastic.

This application is related to the German patent applications DE 10002633.8 and 10002631.1, which are incorporated herein by way of reference.

Components for the engine compartment are usually produced from sheet steel, diecast metal, curable molding compositions, or injection-molded thermoplastics. Together with the corresponding processes, each of the materials mentioned has disadvantages. In the case of injection-molded thermoplastic components, it is often impossible to achieve the tolerances demanded, for example planarities. One of the reasons for this is that the polymer used has marked orientation, predetermined by the material itself and by the gating, and also by the gate position.

Some components for the engine compartment have hitherto been produced in complicated processes using resins which cure or metallic materials with appropriate post-machining.

The object of the present invention consists in providing an economic and environmentally compatible process for producing components for the engine compartment with a relatively high degree of integration.

The object of the present invention is achieved by means of a process for producing components for the engine compartment with a relatively high degree of integration, where at least one thermoplastic polymer is preplastified and the plastified material in the plastic state is laid down in a defined manner in a compression mold and molded in a subsequent compression procedure.

The invention therefore provides the production of components for the engine compartment by the compression molding process.

The invention indicates a new method of processing which uses thermoplastic polymers and which leads to components meeting higher dimensional demands. For this, the material is preplastified and the plastified material while still in a plastic state is laid down in a defined manner in the compression mold and molded in a subsequent compression molding procedure. This means that there is no need for complicated downstream operations. In particular, even complex components can now be produced with appropriate quality features at low production costs. This applies both to components with large height dimensions and to those whose overall height is only small. High fiber lengths can be achieved in the molding, since there is little degradation of the fiber lengths during plastification, and therefore the fiber length of the long-fiber pellets used is substantially retained in the components. The fiber lengths achievable in the component are in the range from 0.5 to 50 mm, preferably from 1 to 25 mm, particularly preferably from 1 to 12 mm. Lower warpage can be achieved through the low anisotropy of shrinkage. Anisotropy of shrinkage is the ratio of longitudinal to transverse shrinkage. Longitudinal shrinkage, i.e. shrinkage in the direction of flow, is generally 0.25%, and transverse shrinkage, i.e. shrinkage perpendicular to the direction of flow, is mostly 0.3%. The long flow paths permit high fiber content when wall thicknesses are low. When the process of the invention is employed, this high fiber content is substantially the same in every region of the molding. The plastified material is a coherent unit whose compact form makes it easy to handle. In one advantageous embodiment of the process of the invention, the shape of the plastified material may be fitted to the molding. In other advantageous embodiments of the process of the invention, the compression molding process may also be carried out using inserts, and in-mold coating is also possible, using textiles and/or films.

Production residues may also be processed in the process of the invention, permitting particularly advantageous in-house recycling.

Long-fiber pellets are generally the term given to thermoplastics which have been reinforced with fibers of length at least 0.5 mm and not more than 50 mm. The length of the fibers is preferably from 1 to 25 mm, in particular from 1 to 12 mm. For these materials, the length of the pellets and that of the fibers are mostly identical. These fibers may have been completely impregnated with the thermoplastic in the pellet, or be present in the form of a glass fiber bundle jacketed by plastic.

It is therefore possible to produce components for the engine compartment, including those with large surface area, at low cost and with a relatively high degree of integration. According to the invention, suitable thermoplastics are those such as polyamides (PA), aromatic polyamides (PPA), polyether sulfides (PES), polyetherimides (PEI), polyurethanes (PU), polyphenylene sulfides (PPS), polyesters (PBT/PET), or polyether ketones (PEEK, PEK), which may comprise filler and/or reinforcing materials, such as carbon fiber, glass fiber, or steel fiber. Suitable thermoplastics are known to the skilled worker and are described by way of example in Kunststoff-Taschenbuch [Plastics handbook] (Saechtling, 27th edition 1998, Hanser Verlag) in part 4 on pages 465-542.

According to the invention, components for the engine compartment can be produced by the compression molding process with a relatively high degree of integration. The components for the engine compartment have a wall thickness of from 0.5 to 50 mm, preferably from 0.5 to 10 mm, particularly preferably from 1 to 5 mm.

It has proven particularly advantageous to use thermoplastics with a specific viscosity and, as fillers and/or reinforcing materials, long fibers, such as glass fibers, carbon fibers, or steel fibers. The novel process permits the stress-free, low-warpage production of a component of the invention for the engine compartment. Contrasting with injection-molded components, even for relatively large differences in wall thickness, the present process complies with very small tolerances. The result is a relatively high degree of integration. The component of the invention for the motor compartment has relatively low weight and high intrinsic damping. The process of the invention has markedly lower production costs. The process of the invention does not require the downstream operations, such as surface grinding, which are an essential requirement with conventional processes. The advantages of the present invention permit the production of moldings, in particular labyrinth plates for automatic gearboxes, with a relatively high degree of integration.

In the process of the invention, long-fiber pellets are treated in a suitable plastifying apparatus, and then the plastified material is placed in the compression mold and molded to give the desired molding. The design criteria for compression molds may be employed for designing the compression mold for this process. Warpage is a less important consideration here than in the design of injection molds, and the design of the molds is therefore simpler and less expensive. The molds have longer service times and the number of castings produced before refurbishment is required is therefore higher, the result being a favorable effect on weight and costs.

The present invention also provides labyrinth plates for automatic gearboxes comprising at least one thermoplastic.

Components for the engine compartment are usually produced from sheet steel, diecast metal, curable molding compositions, or injection-molded thermoplastics. Together with the corresponding processes, each of the materials mentioned has disadvantages. In the case of injection-molded thermoplastic components, it is often impossible to achieve the tolerances demanded, such as planarities. One of the reasons for this is that the polymer used has marked orientation, predetermined by the material itself and by the gating, and also by the gate position.

Labyrinth plates for automatic gearboxes have hitherto usually been produced by a complicated process with the use of metal diecasting with subsequent machining. Labyrinth plates for automatic gearboxes could not hitherto be produced economically from thermoplastics.

Another object of the present invention is to provide labyrinth plates for automatic gearboxes with a relatively high degree of integration, and to provide an economic and environmentally compatible process for their production.

The object of the present invention is achieved in that labyrinth plates for automatic gearboxes with a relatively high degree of integration are obtained from at least one thermoplastic polymer in that at least one thermoplastic polymer is preplastified and the plastified material in the plastic state is laid down in a defined manner in a compression mold and is molded in a subsequent compression molding procedure.

The invention indicates a new method of processing which uses thermoplastic polymers and which leads to components meeting higher dimensional demands. For this, the material is preplastified and the plastified material while still in a plastic state is laid down in a defined manner in the compression mold and molded in a subsequent compression molding procedure. This means that there is no need for complicated downstream operations. In particular, even complex components can now be produced with appropriate quality features at low production costs. This applies both to components with large height dimensions and to those whose overall height is only small.

It is therefore possible to produce plates, including those with large surface area, at low cost and with a relatively high degree of integration. According to the invention, suitable thermoplastics are those such as polyamides (PA), aromatic polyamides (PPA), polyether sulfides (PES), polyetherimides (PEI), polyurethanes (PU), polyphenylene sulfides (PPS), polyesters (PBT/PET), or polyether ketones (PEEK, PEK), which may comprise filler and/or reinforcing materials, such as carbon fiber or glass fiber.

According to the invention it is possible to produce labyrinth plates for automatic gearboxes by the compression molding process. It is possible to produce warpage-free/low-warpage plates of large surface area at low cost with a relatively high degree of integration. The labyrinth plates for automatic gearboxes have a wall thickness of from 0.1 to 30 mm, preferably from 0.5 to 10 mm, particularly preferably from 1 to 5 mm.

It has proven particularly advantageous to use thermoplastics with a specific viscosity and, as fillers and/or reinforcing materials, long fibers, such as glass fibers or carbon fibers. The novel process permits the stress-free, low-warpage production of a labyrinth plate of the invention for automatic gearboxes. Contrasting with injection-molded components, even for relatively large differences in wall thickness, the present process complies with very small tolerances. The result is a relatively high degree of integration. The labyrinth plate of the invention for automatic gearboxes has relatively low weight and high intrinsic damping. The process of the invention has markedly lower production costs. The process of the invention does not require the downstream operations which are an essential requirement with conventional processes.

1. A process for producing components for the engine compartment with a relatively high degree of integration, where at least one thermoplastic polymer is preplastified and the plastified material in the plastic state is laid down in a defined manner in a compression mold and is molded in a subsequent compression procedure.

2. The process as claimed in claim 1, where the thermoplastic polymer comprises one or more polymers such as polyamides (PA), aromatic polyamides (PPA), polyether sulfides (PES), polyetherimides (PEI), polyurethanes (PU), polyphenylene sulfides (PPS), polyesters (PBT/PET), or polyether ketones (PEEK, PEK), which may comprise filler and/or reinforcing materials, such as carbon fiber, glass fiber, or steel fiber.

3. The process as claimed in claim 1 or 2, where the components for the engine compartment have a wall thickness of from 0.1 to 50 mm.

4. The process as claimed in one or more of claims 1 to 4, where the components for the engine compartment have a wall thickness of from 0.5 to 10 mm.

5. The process as claimed in one or more of claims 1 to 5, where the components for the engine compartment have a wall thickness of from 1 to 5 mm.

6. A component for the engine compartment with a relatively high degree of integration, obtainable by a process as claimed in one or more of claims 1 to 6.

7. A labyrinth plate for an automatic gearbox with a relatively high degree of integration, made from at least one thermoplastic polymer obtainable in that at least one thermoplastic polymer is preplastified and the plastified material in the plastic state is laid down in a defined manner in a compression mold and is molded in a subsequent compression procedure.

8. The labyrinth plate as claimed in claim 7, where the thermoplastic polymer comprises one or more polymers such as polyamides (PA), aromatic polyamides (PPA), polyether sulfides (PES), polyetherimides (PEI), polyurethanes (PU), polyphenylene sulfides (PPS), polyesters (PBT/PET), or polyether ketones (PEEK, PEK), which may comprise filler and/or reinforcing materials, such as carbon fiber or glass fiber.

9. The labyrinth plate as claimed in claim 7 or 8, where the plate has a wall thickness of from 0.1 to 30 mm.

10. The labyrinth plate as claimed in one or more of claims 7 to 9, where the plate has a wall thickness of from 0.5 to 10 mm.

11. The labyrinth plate as claimed in one or more of claims 7 to 9, where the plate has a wall thickness of from 1 to 5 mm.

12. A process for producing a labyrinth plate for automatic gearboxes with a relatively high degree of integration, made from at least one thermoplastic polymer, where at least one thermoplastic polymer is preplastified and the plastified material in the plastic state is laid down in a defined manner in a compression mold and is molded in a subsequent compression procedure.
